(19) United States
(12) Patent Application Publication
(10) Pub. No.: US 2008/0265613 A1
(43) Pub. Date: Oct. 30, 2008

(54) Circuit-carrying water deflector and method for making the same

(75) Inventors: Todd L. Hockenberry, Beaver, PA (US); Jeffrey W. Jones, Shaker Heights, OH (US)

Correspondence Address: FAY SHARPE LLP, 1100 SUPERIOR AVENUE, SEVENTH FLOOR, CLEVELAND, OH, 44114, US

(73) Assignee: Excello Engineered Systems, LLC

(21) Appl. No.: 11/880,493

(22) Filed: Jul. 23, 2007

Related U.S. Application Data
(60) Provisional application No. 60/926,310, filed on Apr. 26, 2007.

(51) Int. Cl. B60J 5/00; B21D 53/88; H01R 43/00

(52) U.S. Cl. 296/146.1; 29/825; 29/897.2; 296/191; 296/146.7

(57) ABSTRACT

A protective deflector for application to a vehicle panel to prevent water or dust from entering an interior compartment of the vehicle includes a flexible sheet of plastic film having a peripheral edge shaped to generally conform to a shape of a surface to be protected and a conductive layer overlying and permanently bonded to the flexible sheet, the conductive layer applied in a preselected pattern configured to facilitate electrical connection with one or more vehicle components.

### CLAIM OF PRIORITY

This application claims priority from Provisional Application Ser. No. 60/926,310 filed on Apr. 26, 2007.

### BACKGROUND OF THE INVENTION

The present invention is directed to water deflectors and, more particularly, to a water deflector having a conductive layer for electrical interconnections. The present invention is particularly adapted for use as a water deflector or shield of a type installed relative to a vehicle door panel to prevent the entry of water, dust, air, wind, noise, or other environmental contamination into an interior compartment thereof, and will be described with particular reference thereto. However, it will be appreciated that the invention is equally applicable to use with other vehicle components, such as other vehicle body panels, overheads, instrument panels, floors, and seats, as well as other, entirely unrelated environments.

The metal inner panel of a vehicle door has a plurality of openings and holes therein for mounting certain accessories and mechanisms in the door, and for providing access to such accessories and mechanisms. By way of example, the inner panel of a vehicle door may have openings and holes for mounting such items as window operating mechanisms, locks, remote mirrors, and loudspeakers. The door inner panels for each vehicle body style are normally provided with the same openings and holes so that all of the panels may accommodate the full range of standard and optional equipment which may be housed or included in the doors.

A decorative trim panel and arm rest are conventionally applied over the inner panel of a vehicle door, and it is common to apply a water deflector over the inner door panel for substantially closing the various openings and holes therein for preventing entry of water, dust, and the like, into the vehicle body and for protecting the interior door trim and components mounted thereon from being damaged by water entering the interior of the doors.

Electrical wiring often passes into the region between the inner door panel and the interior trim panel, for example those having power windows, mirrors, door locks, or other door mounted controls. The number and complexity of door-mounted components is increasing, as is the use of signals and sensors circuits, e.g., commonly used with computer or microcontroller-based vehicle information handling systems, thus resulting in large and costly wiring looms which pose assembly and repair difficulties.

Therefore, there exists a need for an integrated water shield and electrical interconnection device which would replace the wiring typically used for electrical signal transmission, and which would reduce wiring complexity and simplify door assembly and repair.

### SUMMARY OF THE INVENTION

The present invention relates to a protective deflector. More particularly, it relates to a protective deflector with a conductive layer with an integrated electrical interconnection device.

In a first aspect of the invention, a protective deflector for application to a vehicle panel to prevent water or dust from entering an interior compartment of the vehicle includes a flexible sheet of plastic film having a peripheral edge shaped to generally conform to a shape of a surface to be protected and a conductive layer overlying and permanently bonded to the flexible sheet. The conductive layer is applied in a preselected pattern configured to facilitate electrical connection with one or more vehicle components.

In a second aspect, a method of forming a flexible circuit-carrying water deflector includes providing a thin, electrically insulating flexible sheet of material and applying a conductive material to a surface of the sheet in a preselected pattern defining a circuit. The conductive material is cured such that the conductive material permanently adheres to the sheet.

In a third aspect, a method of providing an electrical connection between two or more electronic components in a vehicle includes providing a thin, electrically insulating flexible sheet of material and defining a pattern on the sheet on which to build a conductive layer. A conductive material is applied over the defined pattern and the conductive material is cured. The sheet is then installed between a trim panel and a vehicle door panel such that the conductive material provides an electrical coupling between the two or more electronic components.

In a fourth aspect, an improved vehicle door construction is provided. The door construction is of a type having an outer door panel and an inner door panel with a trim panel joined to the inner door panel, wherein a water deflector sheet has a flexible sheet of plastic film and is positioned between the trim panel and the inner door panel, the water deflector sheet having a conductive layer overlying and permanently bonded to the flexible sheet, the conductive layer applied in a preselected pattern configured to facilitate electrical connection with one or more vehicle components.

One aspect of the present water shield resides in its ease of removal and replacement when compared to conventional wiring.

Another aspect of the invention is that the need to fasten wires to the trim panel or sheet metal door panel is eliminated.

Yet another aspect is that all electrical connectors can be mounted on the dry side of the water barrier, thus reducing the cost of the connectors significantly.

Another aspect resides in that the size of circuits can be made large enough to accommodate an automotive door or any other area of the vehicle.

Still another aspect of the present invention resides in the fact that a single circuit design can accommodate all potential vehicle option configurations.

Still another aspect is that the combined water shield/circuit can be easily removed for repair and service.

Yet another aspect resides in that it can be adapted for use with existing standards and protocols, such as plug and play standards, the controller area network (CAN) protocol, and so forth.

Still further aspects of the present invention will become apparent to those of ordinary skill in the art upon reading and understanding the following detailed description of the preferred embodiments.

It is to be understood that both the foregoing general description and the following detailed description are exemplary and explanatory only and are not restrictive of the invention as claimed. The accompanying drawings, which are incorporated in and constitute a part of the specification, illustrate embodiments of the invention and together with the general description, serve to explain the principles of the invention.

### BRIEF DESCRIPTION OF THE DRAWINGS

The following detailed description may be best understood when read in reference to the accompanying drawings wherein:

FIG. 1 is an exploded perspective view of an automobile door employing the circuit-carrying water deflector formed according to the present invention;

FIG. 2 is a cross-sectional elevational view taken along lines 2-2 of FIG. 1;

FIG. 3 is a partial plan view illustrating circuit or conductor terminations in accordance with an alternative embodiment of the invention; and

FIG. 4 is a partial view illustrating a further embodiment of the invention wherein an electronic device is attached directly to the circuit-carrying water deflector.

### DETAILED DESCRIPTION OF THE PREFERRED EMBODIMENTS

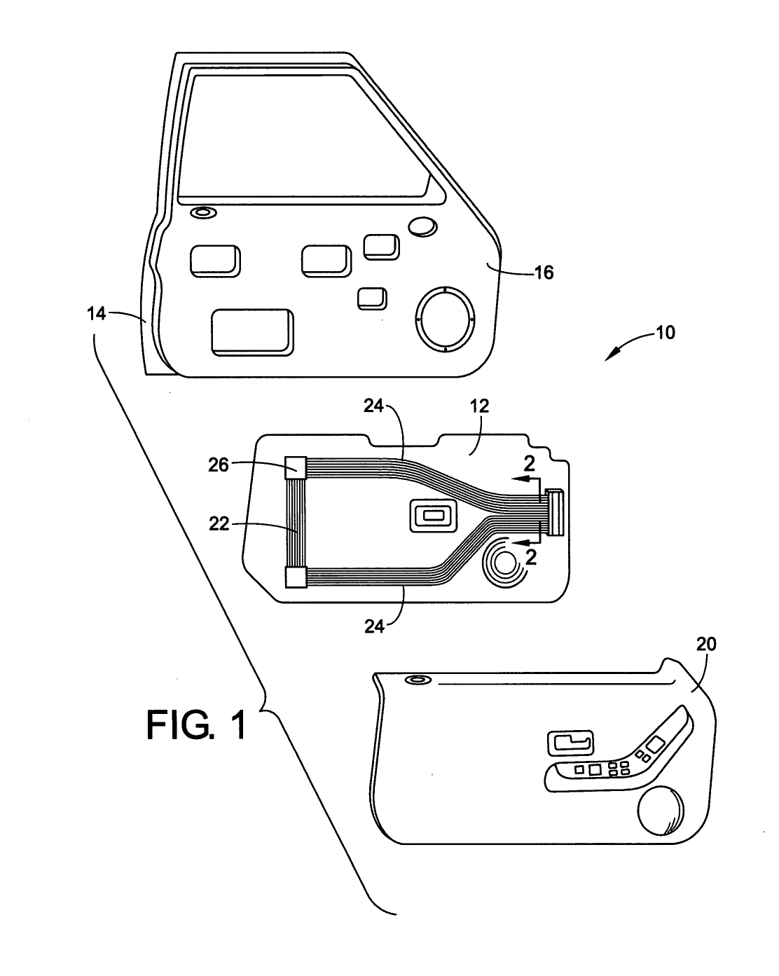

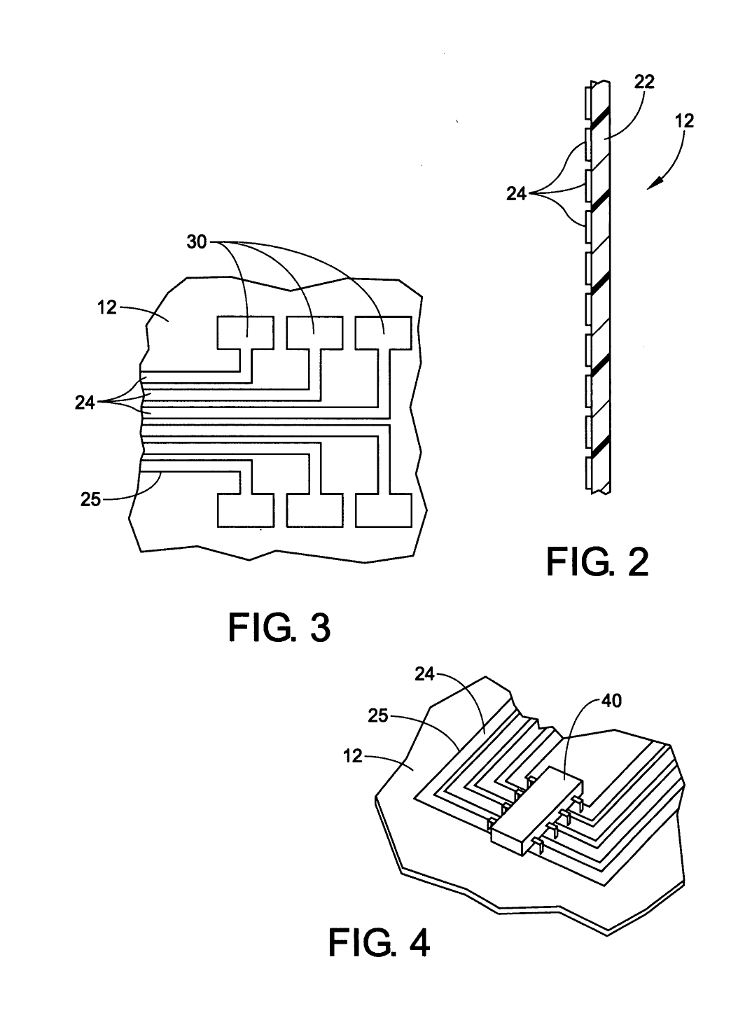

Referring to FIGS. 1 and 2, there is shown an exploded perspective view of a vehicle door 10 employing a circuitized water shield 12 formed in accordance with an embodiment of the present invention. As is well known in the art, the door 10 generally includes an outer panel 14 and an inner panel 16 suitably secured to the outer panel 14, such as by welding along the peripheral edge of panels 14 and 16, the panels defining an internal chamber for accommodating various internal mechanisms.

Water shield 12 is peripherally shaped to substantially cover inner door panel 16. A trim panel 20 is installed over the water shield 12 and the inner panel 16 to form the interior surface of the door 10 and to overlie the various door-mounted components. In application, the water shield 12 provides a wet/dry barrier between the inner door panel and the door trim panel, and serves to deflect water entering the space between the inner and outer door panels. The water is thus retained within the door assembly for drainage out through conventional bottom drain openings instead of wetting the inner door trim panel layer 20 or entering the interior compartment of the vehicle.

The water shield 12 can be mounted to either of the inner door panel 16 or the trim panel 20. Also, the water shield 12 can be inserted between the door panel 16 and the trim panel 20 in a door module assembly. In an alternative embodiment, the door panel 16 is replaced with a frame or other modular/structural member.

Water shield 12 includes a flexible, electrically insulating polymer film material 22, such as polyethylene, polypropylene, and the like. The use of foam materials, such as polyethylene foam, is also contemplated without departing from the scope of the invention. In one embodiment, a corona surface-treated polymer film can be used. The water shield 12 also includes a conductive coating 24 integral with and bonded directly to the film 22. The conductive layer 24 is applied in a circuit pattern of conductive tracings 25 to provide the desired electrical interconnections.

The conductive coating 24 is a composite material including a polymer resin, curable conductive adhesive material, or the like, containing a conductive material, such as a metal powder, dispersed therein. The conductive materials which may be used include, but are not limited to, copper, aluminum, silver, carbon, including graphite and dendritic forms of metals, including copper, and the like. The conductive coating material is preferably applied to the film 22 as an uncured paste or slurry using a printing process, such as a screen printing process. Other printing processes which can be used for depositing or patterning the conductive coating include, for example, flexographic printing, lithographic printing, gravure printing, letterpress printing, or other like printing or graphic arts techniques.

After the desired circuit pattern of tracings 25 is printed on the substrate, it is typically cured using heat, ultraviolet radiation, etc., as appropriate. The conductivity of the imprinted conductors depends on the size of the conductive traces and the concentration of conductive material in the composite. The conductivity is sufficient for the transmission of electronic signals or data, for example, as a part of a computer-based processing system such as a controller area network (CAN)-bus circuit or other vehicle information handling system.

After the circuit is applied in a selected pattern and cured, the water deflector is cut, e.g., die cut, to the desired size and peripheral shape, which generally conforms to the peripheral size and shape of the surface to be protected. Also, any additional processing steps are also performed, such as providing deflectable or laterally displaceable regions, providing slits or other openings, etc., in a manner well known in the art. Alternatively, the steps of cutting and/or otherwise processing the flexible sheets 22 can be performed prior to application of the circuit pattern.

The water shield 12 optionally further includes one or more electrical connectors 26 mounted thereon electrically connected to the circuit pattern of tracings 25. Each connector 26 is in aligned position with a mating connector (not shown) on the trim panel 20 or door panel 16. The connectors are adhesively applied on the dry side of the barrier, e.g., using a conductive adhesive which provides an electrical coupling between the printed circuit traces and connector terminals or contacts. In one embodiment, the connectors are preassembled and adhesively applied to the barrier at a centralized location. The conductive tracings and connectors provide an electrical interconnection between switches, sensors, controller modules, and the like, thereby eliminating the need for separate wire connections and thus reducing the number of wires in the wiring loom.

In a first embodiment, all of the connectors 26 are located on the dry (interior facing) side of the water shield 12. In this manner, the connectors are protected from environmental contamination and location and attachment of the water shield is simplified. In an alternative embodiment, a conductive pattern is applied to both sides of the film 22 forming the water shield 12.

In one embodiment, the conductors and connectors conform to a standard communication protocol, such as the CAN-bus protocol, or other promulgated standard for data or signal transmission.

In the embodiment shown in FIG. 3, a water deflector without electrical connections is illustrated. Connection to an electrical power source or external circuitry is made by bonding external circuit terminations with conductive bonding pad regions 30 which are connected to the circuit pattern 25 of conductive layer 24. Connection can be made using a conductive adhesive, solder, and the like.

In the embodiment of FIG. 4, the conductive circuit pattern 25 of conductive layer 24 is adapted for bonding an electronic device 40, such as an IC chip or other surface mount device, directly to the water shield 12.

Optionally, an insulating layer is applied over the conductive material to prevent short circuiting of the conductive traces by moisture, vehicle sheet metal, or other conductors which may come in contact with the water deflector.

The trim panel is attached to the inner door panel using clips, screws, snap-type fasteners, and the like, in a known manner, the water shield 12 interposed between the trim panel 20 and the inner door panel 16. Water shield 12 is attached to either or both of trim panel 20 and door panel 16, in a known manner, for example, using a removable or permanent pressure-sensitive adhesive, or the like. In one embodiment, the water deflector 12 is first attached to the trim panel 20, and the combined trim panel and water deflector is then installed onto the door panel 16 as a single unit.

The trim panel layer 12 generally includes a structural material, such as a plastic, metal, composite, laminate, or other material generally used in the construction of automotive interior trim panels, which is molded or otherwise formed to the needed functional and aesthetic shape. The trim panel layer may further include decorative materials, such as cloth, leather, plastic, foam, vinyl, carpet, or other material generally used in the construction of automotive interior trim panels.

The invention has been described with reference to the preferred embodiments. Obviously, modifications and alterations will occur to others upon a reading and understanding of this specification. The forms hereinbefore described being merely explanatory and exemplary, it is intended that the invention be construed as including all such modifications and alterations insofar as they come within the scope of the appended claims or the equivalents thereof.

1. A protective deflector for application to a vehicle panel, comprising:
a flexible sheet having a peripheral edge shaped to generally conform to a shape of a surface to be protected; and
a conductive layer overlying and bonded to said flexible sheet, wherein
said conductive layer is applied in a preselected pattern configured to facilitate electrical connection with at least one associated vehicle component.

2. The protective deflector of claim 1, wherein said flexible sheet comprises an electrically insulating polymer film material.

3. The protective deflector of claim 1, wherein said conductive layer comprises a polymer resin having a conductive metal therein.

4. The protective deflector of claim 1, wherein said conductive layer is printed onto said flexible sheet.

5. The protective deflector of claim 4, wherein said conductive layer is cured.

6. The protective deflector of claim 1, wherein said conductive layer is applied to said flexible sheet in a circuit pattern of conductive tracings.

7. The protective deflector of claim 6, wherein said flexible sheet comprises one or more electrical connectors mounted thereon, which are electrically connected to the conductive tracings.

8. The protective deflector of claim 7, wherein said connectors are located on a dry side of said flexible sheet.

9. The protective deflector of claim 7, wherein said connectors are located on opposite sides of said flexible sheet.

10. The protective deflector of claim 7, wherein said connectors conform to CAN-bus protocol.

11. The protective deflector of claim 1, wherein said flexible sheet comprises conductive bonding pad regions for connecting external circuitry to said flexible sheet.

12. The protective deflector of claim 1, wherein said conductive layer is adapted for bonding an electronic device directly to the flexible sheet.

13. A method of forming a flexible circuit-carrying water deflector comprising:
providing an electrically insulating flexible sheet, and
applying a conductive material to a surface of the sheet in a preselected pattern defining a circuit.

14. The method of claim 13, further comprising:
curing said conductive material such that said conductive material adheres to said sheet.

15. A method of providing an electrical connection between two or more electronic components in a vehicle, comprising:
providing an electrically insulating flexible sheet;
defining a pattern onto the sheet on which to build a conductive layer;
applying a conductive material over the pattern;
curing the conductive material; and
installing said sheet between a trim panel and a vehicle door panel such that the conductive material provides an electrical coupling between said two or more electronic components.

16. A vehicle door, comprising:
a door panel;
a trim panel connected to said door panel;
a protective deflector comprising a flexible sheet positioned between said trim panel and said door panel;
wherein said protective deflector comprises a conductive layer bonded to said flexible sheet, said conductive layer being applied in a preselected pattern configured to facilitate electrical connection with one or more vehicle components.

17. The vehicle door of claim 16, wherein said trim panel is secured to said door panel via fasteners.

18. The vehicle door of claim 16, wherein said protective deflector is attached to at least one of said trim panel and said door panel via a pressure sensitive adhesive.
